(19) United States
(12) Patent Application Publication
(10) Pub. No.: US 2014/0154292 A1
(43) Pub. Date: Jun. 5, 2014

(54) GLASS FRIT ANTIMICROBIAL COATING

(71) Applicant: CORNING INCORPORATED, CORNING, NY (US)

(72) Inventors: Nicholas Francis Borrelli, Elmira, NY (US); Melinda Ann Drake, Corning, NY (US); Robert Michael Morena, Lindley, NY (US)

(73) Assignee: CORNING INCORPORATED, Corning, NY (US)

(21) Appl. No.: 14/086,227

(22) Filed: Nov. 21, 2013

Related U.S. Application Data
(60) Provisional application No. 61/731,765, filed on Nov. 30, 2012.

(51) Int. Cl. A01N 59/20; A01N 59/16

(52) U.S. Cl. CPC A01N 59/20; A01N 59/16
USPC 424/400; 424/630; 424/618; 424/646; 424/649; 424/641

(57) ABSTRACT

Articles have a glass layer on a substrate. The glass layer has antimicrobial properties via a metal or metal alloy. The glass layer is made using a doped glass frit which may be deposited by screen printing. The CTE of the glass layer and the substrate can be matched.

### CROSS-REFERENCE TO RELATED APPLICATIONS

This application claims the benefit of priority under 35 U.S.C. §119 of U.S. Provisional Application Ser. No. 61/731,765 filed on Nov. 30, 2012 the contents of which are relied upon and incorporated herein by reference in their entirety as if fully set forth below.

### FIELD

This disclosure relates to an antimicrobial coating, and more particularly to an antimicrobial coating comprising a glass frit.

### BACKGROUND

In many places, for example, public places such as hospitals, libraries, and banks to name a few, there is a great need for antimicrobial materials, particularly antimicrobial coatings on surfaces, to help prevent the spread of diseases, typically by helping to prevent viruses or bacteria from harboring and spreading from one person to another. Copper and silver are two antimicrobial metals that have been used. Copper, Cu, has officially been approved by the U.S. Environmental Protection Agency (EPA) as an antimicrobial material since 2008.

In recent years much effort has been made to develop methods and processes of making Cu-based materials, including Cu-based alloys, for antimicrobial applications. However, many Cu-based antimicrobial materials face two big technical challenges which are (1) low antimicrobial activity and (2) low lifetime of the antimicrobial activity. Known Cu-based antimicrobial materials exhibit low antimicrobial activity because in most cases the materials that contain active Cu contain it in a manner that does not readily enable contact between the copper and the bacteria or viruses. Such contact is necessary to enable the copper, or copper ions derived from the copper, to enter into the bacterium or virus.

### SUMMARY

One embodiment is an article comprising a substrate; and a metal, metal alloy, or combinations thereof containing glass layer on the substrate, wherein the metal, metal alloy, or combinations thereof containing glass layer is a fired mixture of a glass frit and metal, metal alloy, or combinations thereof, wherein the metal, metal alloy, or combinations thereof is dispersed throughout the glass layer and at a surface of the glass layer, and wherein the glass layer has antimicrobial properties.

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the claims. The accompanying drawings are included to provide a further understanding, and are incorporated in and constitute a part of this specification. The drawings illustrate one or more embodiment(s), and together with the description serve to explain principles and operation of the various embodiments.

### BRIEF DESCRIPTION OF THE DRAWINGS

FIG. 1 is an illustration of an article according to some embodiments.

### DETAILED DESCRIPTION

Reference will now be made in detail to various embodiments of antimicrobial composite materials and their use in coatings, examples of which are illustrated in the accompanying drawings. Whenever possible, the same reference numerals will be used throughout the drawings to refer to the same or like parts.

As used herein the term “antimicrobial” means an agent or material, or a surface containing the agent or material that will kill or inhibit the growth of microbes from at least two of families consisting of bacteria, viruses and fungi. The term as used herein does not mean it will kill or inhibit the growth of all species of microbes within such families, but that it will kill or inhibit the growth of one or more species of microbes from such families.

As used herein the term “Log “Reduction” or “LR” means Log (Cₐ /C₀), where Cₐ=the colony form unit (CFU) number of the antimicrobial surface containing copper ions and C₀=the colony form unit (CFU) of the control glass surface that does not contain copper ions. That is:

LR=−Log (Cₐ/C₀),

As an example, a Log Reduction of 4=99.9% of the bacteria or virus killed and a Log Reduction of 6=99.999% of bacteria or virus killed.

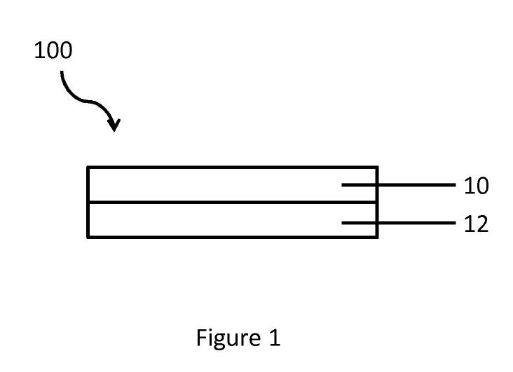

One embodiment, an example shown in FIG. 1, is an article 100 comprising a substrate 10; and a metal, metal alloy, or combinations thereof containing glass layer 12 on the substrate, wherein the metal, metal alloy, or combinations thereof containing glass layer is a fired mixture of a glass frit and metal, metal alloy, or combinations thereof, wherein the metal, metal alloy, or combinations thereof is dispersed throughout the glass layer and at a surface of the glass layer, and wherein the glass layer has antimicrobial properties.

The metal, metal alloy, or combinations thereof can be copper, silver, palladium, platinum, gold, nickel, zinc and combinations thereof, for example, the metal can be copper or silver, or the metal alloy can be a copper alloy such as copper nickel or copper chromium. In some embodiments, at least about 10 percent by volume of the metal, metal alloy, or combinations thereof is in a reduced state. In some embodiments, the metal is Ag ions. In some embodiments, the metal is Cu. In some embodiments, the metal is a combination of Ag ions and Cu. In some embodiments, the metal is a combination of Ag ions and reduced Cu. In one embodiment, the metal is copper, the copper is in a reduced state, for example, Cu⁰, Cu⁺¹, or combinations thereof. Copper in a reduced state provides advantaged antimicrobial activity as compared to copper in an oxidized state which may be oxidized when exposed to oxygen, for example, in air. Therefore, it may be advantageous for the copper to be in a reduced state such that Cu⁰, Cu⁺¹, or combinations thereof are present at a percentage of at least about 10 percent by volume. When the metal alloy is a copper alloy, it may be advantageous for the copper in the copper alloy to be in a reduced state such that Cu⁰, Cu⁺¹, or combinations thereof are present at a percentage of at least about 60 percent by volume of the total copper, for example, about 60 to about 100 percent, about 61 to about 100 percent, about 62 to about 100 percent, about 63 to about 100 percent, about 64 to about 100 percent, about 65 to about 100 percent, about 66 to about 100 percent, about 67 to about 100 percent, about 68 to about 100 percent, about 69 to about 100 percent, about 70 to about 100 percent, about 71 to about 100 percent, about 72 to about 100 percent, about 73 to about 100 percent, about 74 to about 100 percent, about 75 to about 100 percent, about 76 to about 100 percent, about 77 to about 100 percent, about 78 to about 100 percent, about 79 to about 100 percent, about 80 to about 100 percent, about 81 to about 100 percent, about 82 to about 100 percent, about 83 to about 100 percent, about 84 to about 100 percent, about 85 to about 100 percent, about 86 to about 100 percent, about 87 to about 100 percent, about 88 to about 100 percent, about 89 to about 100 percent, about 90 to about 100 percent, about 91 to about 100 percent, about 92 to about 100 percent, about 93 to about 100 percent, about 94 to about 100 percent, about 95 to about 100 percent.

The a metal, metal alloy, or combinations thereof can be particles and can have an average size in the range of from about 2 nm to about 4 microns, for example, about 5 nm to about 4 microns, about 10 nm to about 4 microns, about 25 nm to about 4 microns, about 50 nm to about 4 microns, about 75 nm to about 4 microns, about 100 nm to about 4 microns, about 125 nm to about 4 microns, about 150 nm to about 4 microns, about 175 nm to about 4 microns, about 200 nm to about 4 microns, about 225 nm to about 4 microns, about 250 nm to about 4 microns, about 275 nm to about 4 microns, about 300 nm to about 4 microns, about 325 nm to about 4 microns, about 350 nm to about 4 microns, about 375 nm to about 4 microns, about 400 nm to about 4 microns, about 425 nm to about 4 microns, about 450 nm to about 4 microns, about 475 nm to about 4 microns, about 500 nm to about 4 microns, about 525 nm to about 4 microns, about 550 nm to about 4 microns, about 575 nm to about 4 microns, about 600 nm to about 4 microns, about 625 nm to about 4 microns, about 650 nm to about 4 microns, about 675 nm to about 4 microns, about 700 nm to about 4 microns, about 725 nm to about 4 microns, about 750 nm to about 4 microns, about 775 nm to about 4 microns, about 800 nm to about 4 microns, about 825 nm to about 4 microns, about 850 nm to about 4 microns, about 875 nm to about 4 microns, about 900 nm to about 4 microns, about 925 nm to about 4 microns, about 950 nm to about 4 microns, about 975 nm to about 4 microns, about 1 micron to about 4 microns. In some embodiments, the particles have an average size in the range of from about 200 nm to about 4 microns, for example, about 200 nm to about 3.9 microns, about 200 nm to about 3.8 microns, about 200 nm to about 3.7 microns, about 200 nm to about 3.6 microns about 200 nm to about 3.5 microns, about 200 nm to about 3.4 microns, about 200 nm to about 3.2 microns, about 200 nm to about 3.1 microns, about 200 nm to about 3.0 microns, about 200 nm to about 2.9 microns, about 200 nm to about 2.8 microns, about 200 nm to about 2.7 microns, about 200 nm to about 2.6 microns, about 200 nm to about 2.5 microns, about 200 nm to about 2.4 microns, about 200 nm to about 2.3 microns, about 200 nm to about 2.2 microns, about 200 nm to about 2.1 microns, about 200 nm to about 2.0 microns.

The glass layer, in some embodiments, has an average thickness in the range of from 1 to 20 microns. In order to increase thickness, multiple layers of glass frit can be applied to the substrate. In this case, each glass layer can have an average thickness in the range of from 1 to 20 microns (i.e. 10 glass frit layers, after firing, can each have a thickness of 15 microns for a total thickness of 150 microns).

The substrate can be glass, chemically strengthened glass, glass-ceramic, ceramic, metal, wood, plastic, porcelain, or combinations thereof. The substrates or articles can be, for example, antimicrobial shelving, table tops, counter tops, tiles, walls, bedrails, and other applications in hospitals, laboratories and other institutions handling biological substances. The substrate in some embodiments can be multi-layered. The coefficient of thermal expansion of the substrate and the glass layer are within ±10×10⁻⁷/° C. of each other in some embodiments, for example, ±9×10⁻⁷/° C., for example, ±8'10⁻⁷/° C., for example, ±7×10⁻⁷/° C., for example, ±6×10⁻⁷/° C., for example, ±5×10⁻⁷/° C., for example, ±4×10⁻⁷/° C., for example, ±3×10⁻⁷/° C., for example, ±2×10⁻⁷/° C., for example, ±1×10⁻⁷/° C.

Typical methods of reducing copper, for example, Cu⁺¹ to Cu⁰, include treating the Cu⁺¹ with H₂SO₄. A disproportional reaction occurs which wastes about 50% of the volume of the starting Cu⁺¹ because half of the Cu⁺¹ turns to Cu⁺² that washes away with the water in the washing step. Thus, in one embodiment, the method comprises a hydrogen reducing process. The hydrogen reducing process can comprise reducing Cu⁺¹ to Cu⁰ in a reducing atmosphere comprising hydrogen, nitrogen, or combinations thereof. The hydrogen reducing process can comprise placing the articles disclosed herein in an atmosphere of H₂, N_{2,} or a mixture of H₂/N₂ with 6-8% H₂ (wt) at a temperature of about 300° C. to about 320° C. for 48 hours. This reducing step can maximize the transfer of the Cu⁺¹ to Cu⁰ without the about 50% loss described above.

### EXAMPLES

Cu-doped frit was reduced to particles by ball milling then was combined with an organic binder to make a “paste”. The paste was then screen printed on the desired compatible glass substrate. The thermal processing was the following: 350° C. for one hour followed by 600° C. for 2 hours leading to a dense layer of the Cu-containing glass on the substrate.

The Cu-frit glass layer had an average thickness of 15 um. The substrate and glass layer were put through a further treatment to reduce the Cu-ions in the glass layer to Cu-metal nanoparticles. This was done by treatment in pure H₂ at 450° C. for 5 h. (This treatment can be done at lower temperature and shorter time). The antimicrobial behavior is different depending on the state of the copper as is observed in Table 6 from the antibacterial test results.

The test results from the outside Lab “Antimicrobial Test Laboratory in Texas” following the EPA protocol and E. coli ATCC as the bacteria found the results shown in Table 6.

Antibacterial tests were carried out using cultured gram negative E. coli; DH5 alpha-Invitrogen Catalog No. 18258012, Lot No. 7672225, rendered Kanamycin resistant through a transformation with PucI9 (Invitogen) plasmid. The bacteria culture was started using either LB Kan Broth (Teknova #L8145) or Tryptic Soy Broth (Teknova # T1550). Approximately 2 μl of overnight cultured liquid bacteria suspension or a pipette tip full of bacteria were streaked from an agar plate and dispensed into a capped tube containing 2-3 ml of broth and incubated overnight at 37° C. in a shaking incubator. The next day the bacteria culture was removed from the incubator and washed twice with PBS. The optical density (OD) was measured and the cell culture was diluted to a final bacterial concentration of approximately 1×10⁵ CFU/ml. The cells were placed on the copper contained Polycrylic surface and Polycrylic surface control (1×1 inch), covered with Parafilm™ and incubated for 6 hours at 37° C. with saturated humidity. Afterward, the buffers from each surface were collected and the plates were twice washed with ice-cold PBS. For each well the buffer and wash were combined and the surface spread-plate method was used for colony counting.

Antibacterial testing, for example, antibacterial-dry test were performed on several exemplary glass layers. Each testing sample glass was cut into a glass slide of 1×1 inch² and put into petridish in triplicate. Non copper doped (uncoated) glass slides were used as negative controls. Gram positive Staphylococcus aureus bacterial were cultured for at least 3 consecutive days before, on the day of testing, the inocula has been culture for at least 48 hours. Vortex the bacterial culture, add serum(5% final concentration) and Triton X-100 (final concentration 0.01%) to the inocula. Inoculate each samples with 20 ul aliquot of the bacterial suspension, allow samples to dry for 30˜40 minutes in room temperature, at 42% relative humidity. Right after samples drying, two hour exposure time start to count. After 2 hours, 4 ml of PBS buffer was added into each petridish. After shaking, all the solution from each petridish was collected and placed onto Trypticase soy agar plate. After further 24 hr incubation at 37° C. incubator, bacteria colony formation was examined Geometric mean were used to calculate the log and percent reduction based on the colony number glass and control glass.

Tables 1-5 show exemplary glass frit compositions.

TABLE 1

Example

| (Mol %) | 1 | 2 | 3 | 4 | 5 | 6 |
|---|---|---|---|---|---|---|
| Al₂O₃ | 12.4 | 12.38 | 12.38 | 12.38 | 12.4 | 12.38 |
| Li₂O | 6.06 | 6.06 | 6.06 | 6.06 | 6.06 | 6.06 |
| MgO | 2.89 | 2.89 | 2.89 | 2.89 | 2.89 | 2.89 |
| SiO₂ | 74.2 | 74.24 | 74.24 | 74.24 | 74.2 | 74.24 |
| BaO | 0.32 | 0.32 | 0.32 | 0.32 | 0.32 | 0.32 |
| ZnO | 0.8 | 0.8 | 0.8 | 0.8 | 0.8 | 0.8 |
| TiO₂ | 2.11 | 2.11 | 2.11 | 2.11 | 2.11 | 2.11 |
| ZrO₂ | 0.95 | 0.95 | 0.95 | 0.95 | 0.95 | 0.95 |
| SnO₂ | 0.25 | 0.25 | 0.25 | 0.25 | 0.25 | 0.25 |
| CuO | 5 | 10 | 5 | 10 | 0 | 0 |
| Ag | | | | | 1 | 0.5 |

Example

| (Mol %) | 7 | 8 | 9 | 10 | 11 | 12 |
|---|---|---|---|---|---|---|
| Al₂O₃ | 12.38 | 12.38 | 14.7 | 17.08 | 12.38 | 12.38 |
| Li₂O | 6.06 | 6.06 | 6.06 | 6.06 | 6.06 | 6.06 |
| MgO | 2.89 | 2.89 | 2.89 | 2.89 | 2.89 | 2.89 |
| SiO₂ | 74.24 | 74.24 | 74.2 | 74.24 | 74.24 | 74.24 |
| BaO | 0.32 | 0.32 | 0.32 | 0.32 | 0.32 | 0.32 |
| ZnO | 0.8 | 0.8 | 0.8 | 0.8 | 0.8 | 0.8 |
| TiO₂ | 2.11 | 2.11 | 2.11 | 2.11 | 2.11 | 2.11 |
| ZrO₂ | 0.95 | 0.95 | 0.95 | 0.95 | 0.95 | 0.95 |
| SnO₂ | 0.25 | 0.25 | 0.25 | 0.25 | 0.25 | 0.25 |
| CuO | 1 | 0.5 | 2.65 | 5.3 | 1 | 1 |
| Ag | 0 | 0 | | | 1 | 0.5 |

TABLE 2

| | Example | | | | | |
|---|---|---|---|---|---|---|
| (Mol %) | 13 | 14 | 15 | 16 | 17 | 18 |
| SiO₂ | 43.4 | 43.38 | 40.88 | 40.88 | 43.4 | 43.38 |
| B₂O₃ | 35.3 | 38.29 | 38.29 | 38.29 | 38.3 | 38.29 |
| Na₂O | 6.3 | 0 | | | | |
| K₂O | 1.8 | 8.33 | 8.33 | 8.33 | 13.3 | 13.33 |
| ZnO | 5 | 5 | 2.5 | 2.5 | 5 | 5 |
| Li₂O | 3 | 0 | | | | |
| CuO | 5 | 5 | 10 | 10 | 1 | 0.5 |
| Tg (° C.) | 459 | 449 | | | | |
| CTE (10⁻⁷/° C.) | 65* | 67* | | | 83** | 85** |
| Softening Point (° C.) | 698* | 608* | | | | |

*were sintered at 350/1 h, 625/2 h
**were sintered at 625/1 h

TABLE 3

Example

| (Mol %) | 19 | 20 |
|---|---|---|
| SiO₂ | 62.1 | 62.1 |
| B₂O₃ | 12.1 | 12.1 |
| Al₂O₃ | 5.8 | 5.8 |
| Na₂O | 8.2 | 8.2 |
| Li₂O | 2.7 | 2.7 |
| K₂O | 1.1 | 1.1 |
| MgO | 2.8 | 2.8 |
| CaO | 4.6 | 4.6 |
| ZrO₂ | 0.7 | 0.7 |
| CuO | 10 | 10 |

TABLE 4

Example

| (Mol %) | 21 | 22 |
|---|---|---|
| Li₂O | 21 | 21 |
| Na₂O | 21 | 21 |
| P₂O₅ | 47.2 | 47.2 |
| B₂O₃ | 5 | 5 |
| Al₂O₃ | 2 | 2 |
| ZnO | 3.7 | 3.7 |
| CuO | 10 | 10 |

TABLE 5

| | Example |
|---|---|
| (Mol %) | 23 |
| SiO₂ | 78.1 |
| B₂O₃ | 20.4 |
| K₂O | 1.5 |
| CuO | 10 |

TABLE 6

| | | | |
|---|---|---|---|
| As-made Cu Glass Frit | Cu⁺² state | 91.25% kill | log kill = 1.06 |
| Hydrogen Treated Cu | Cu⁺¹ or Cu⁰ state | >99.99% kill | log kill = >5 |
| glass Frit | | | |
| As-made Cu Glass Frit | Cu⁺² state | 50.56% | |
| Hydrogen Treated Cu | Cu⁺¹ or Cu⁰ state | 88.33% | |
| glass Frit | | | |
| As-made Cu Glass Frit | Cu⁺² state | 87.41% | |
| Hydrogen Treated Cu | Cu⁺¹ or Cu⁰ state | 92.72% | |
| glass Frit | | | |

It will be apparent to those skilled in the art that various modifications and variations can be made to the embodiments described herein without departing from the spirit and scope of the claimed subject matter. Thus it is intended that the specification cover the modifications and variations of the various embodiments described herein provided such modification and variations come within the scope of the appended claims and their equivalents.

What is claimed is:

1. An article comprising a substrate; and a metal, metal alloy, or combinations thereof containing glass layer on the substrate, wherein the metal, metal alloy, or combinations thereof containing glass layer is a fired mixture of a glass frit and metal, metal alloy, or combinations thereof, wherein the metal, metal alloy, or combinations thereof is dispersed throughout the glass layer and at a surface of the glass layer, and wherein the glass layer has antimicrobial properties.

2. The article according to claim 1, wherein the metal, metal alloy, or combinations thereof comprises copper, silver, palladium, platinum, gold, nickel, zinc or combinations thereof.

3. The article according to claim 1, wherein the metal, metal alloy, or combinations thereof comprises copper.

4. The article according to claim 3, wherein the copper is selected from the group consisting of Cu ions, metallic copper, colloidal copper, copper nanoparticles, and combinations thereof.

5. The article according to claim 3, wherein the copper is in a reduced state.

6. The article according to claim 1, wherein the coefficient of thermal expansion of the substrate and the glass layer are within ±10×10⁻⁷/° C. of each other.

7. The article according to claim 1, wherein the glass frit comprises a composition comprising in mole percent:
40-80 SiO₂;
0-15 Al₂O₃;
0-40 B₂O₃;
0-15 M₂O, wherein M is an alkali metal;
0-15 RO, wherein R is an alkaline earth metal; and
0.5-15 Cu, Ag, or a combination thereof.

8. The article according to claim 7, wherein the composition further comprises 0-5 mole percent ZnO, SnO₂, ZrO₂, TiO₂.

9. The article according to claim 7, wherein the glass frit comprises a composition comprising in mole percent:
40-80 SiO₂;
0-15 Al₂O₃;
0-40 B₂O₃;
1-15 M₂O, wherein M is an alkali metal;
1-15 RO, wherein R is an alkaline earth metal; and 0.5-15 Cu, Ag, or a combination thereof.

10. The article according to claim 9, wherein the composition comprises 10-40 B₂O₃.

11. The article according to claim 9, wherein the composition comprises 5-15 Al₂O₃.

12. The article according to claim 1, wherein the glass frit comprises a composition comprising in mole percent:
0-10 Al₂O₃;
0-60 P₂O₅;
0-10 B₂O₃;
0-50 M₂O, wherein M is an alkali metal;
0-15 RO, wherein R is an alkaline earth metal; and
0.5-15 Cu, Ag, or a combination thereof.

13. The article according to claim 9, wherein the glass frit comprises a composition comprising in mole percent:
1-10 Al₂O₃;
30-60 P₂O₅;
1-10 B₂O₃;
10-50 M₂O, wherein M is an alkali metal;
1-15 RO, wherein R is an alkaline earth metal; and
0.5-15 Cu, Ag, or a combination thereof.

14. The article according to claim 10, wherein M is Na, Li, or a combination thereof.

15. The article according to claim 1, wherein the glass layer has a thickness in the range of from 1 to 20 microns.

16. The article according to claim 1, wherein the substrate is comprised of glass, chemically strengthened glass, glass-ceramic, ceramic, metal, wood, plastic, porcelain, or combinations thereof.

17. The article according to claim 1, having a log reduction≧1.

18. The article according to claim 1, wherein the substrate is comprised of an aluminoborosilicate or borosilicate glass.
